(19) United States
(12) Patent Application Publication
(10) Pub. No.: US 2004/0064358 A1
(43) Pub. Date: Apr. 1, 2004

(54) Method and system for marketing whole product offerings to clients

(76) Inventors: Joe R. Hill, Austin, TX (US); Thomas L. Hill, Dallas, TX (US); Jeffry L. Buchmiller, Pilot Point, TX (US)

Correspondence Address: BAKER BOTTS L.L.P., 2001 ROSS AVENUE, SUITE 600, DALLAS, TX, 75201-2980, US

(21) Appl. No.: 10/256,965

(22) Filed: Sep. 26, 2002

(51) Int. Cl. G06F 17/60

(52) U.S. Cl. 705/10

(57) ABSTRACT

According to one embodiment of the invention, a computerized method used in marketing whole product offerings to clients includes identifying that a first respondent of a client fits into a first segment of a plurality of segments of a technology adoption profile for the client, identifying that a first whole product offering of a company fits into a first phase of a plurality of phases of a technology market development phase model for a plurality of whole product offerings of the company, comparing the first segment to the first phase, and generating an output, based on the comparison, to determine whether to market the first whole product offering to the first respondent.

### TECHNICAL FIELD OF THE INVENTION

The present invention relates generally to the field of targeted marketing and, more particularly, to a method and system for marketing whole product offerings to clients.

### BACKGROUND OF THE INVENTION

Large companies in the technology industry often have a wide array of whole product offerings and a wide variety of clients. This combination makes it difficult for every client-serving employee to match whole product offerings with clients effectively. Compounding this difficulty nowadays is the highly technological and complex nature of whole product offerings. Client-serving employees, such as account managers, find it difficult to keep up with the large list of whole product offerings because the list is changing often in response to rapid changes in the technological environment in which the company operates. Client-serving employees also find it difficult to understand each of their company's whole product offerings because these modem technological whole product offerings are inherently complex. Even with some understanding of a whole product offering, it is usually not obvious to every client-serving employee whether their client or other clients could utilize this whole product offering. Even if these whole product offerings are well understood by the company's client-serving employees, it is often still not obvious which particular clients are of the type or in a position to utilize any particular whole product offering.

### SUMMARY OF THE INVENTION

According to one embodiment of the invention, a computerized method used in marketing whole product offerings to clients includes identifying that a first respondent of a client fits into a first segment of a plurality of segments of a technology adoption profile for the client, identifying that a first whole product offering of a company fits into a first phase of a plurality of phases of a technology market development phase model for a plurality of whole product offerings of the company, comparing the first segment to the first phase, and generating an output, based on the comparison, to determine whether to market the first whole product offering to the first respondent.

Embodiments of the invention provide a number of technical advantages. Embodiments of the invention may include all, some, or none of these advantages. For example, sales of profit-generating whole product offerings may be optimized by offering them to the respondents of clients that are most ready to utilize them. Whole product offering managers/account managers are better able to match the myriad of whole product offerings that their company offers to their clients' needs. Having the ability to match whole product offerings with respondents more effectively facilitates better and more meaningful discussions between client-serving employees and the respondents of their clients. In addition, a company's whole product offerings may be more effectively utilized and maintained, potentially resulting in combined whole product offerings, new whole product offerings, or eradicated whole product offerings that are not turning profits. Having an efficient way to match respondents with whole product offerings also may help a company's long term relationship with a respondent/client by showing a respondent that the company is offering a stream of ever-more-technologically advanced whole product offerings at the level of maturity with which the respondent is comfortable.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a block diagram illustrating a method of marketing whole product offerings to clients according to one embodiment of the present invention;

FIG. 2 is a graph of a technology adoption profile for a client versus a technology market development phase model for whole product offerings of a company in accordance with one embodiment of the present invention;

FIG. 3 is a block diagram of a computer for use in carrying out one embodiment of the method of FIG. 1;

FIG. 4 illustrates example queries presented to a respondent of a client in accordance with one embodiment of the present invention; and

FIG. 5 is a flowchart illustrating a method of marketing whole product offerings to clients according to one embodiment of the present invention.

### DETAILED DESCRIPTION OF EXAMPLE EMBODIMENTS OF THE INVENTION

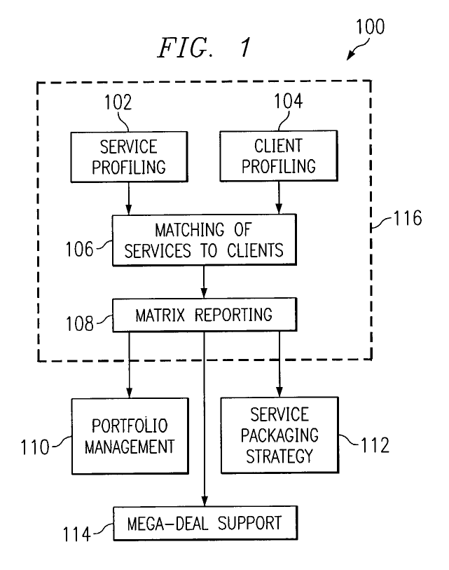

Example embodiments of the present invention and their advantages are best understood by referring now to FIGS. 1 through 5 of the drawings, in which like numerals refer to like parts.

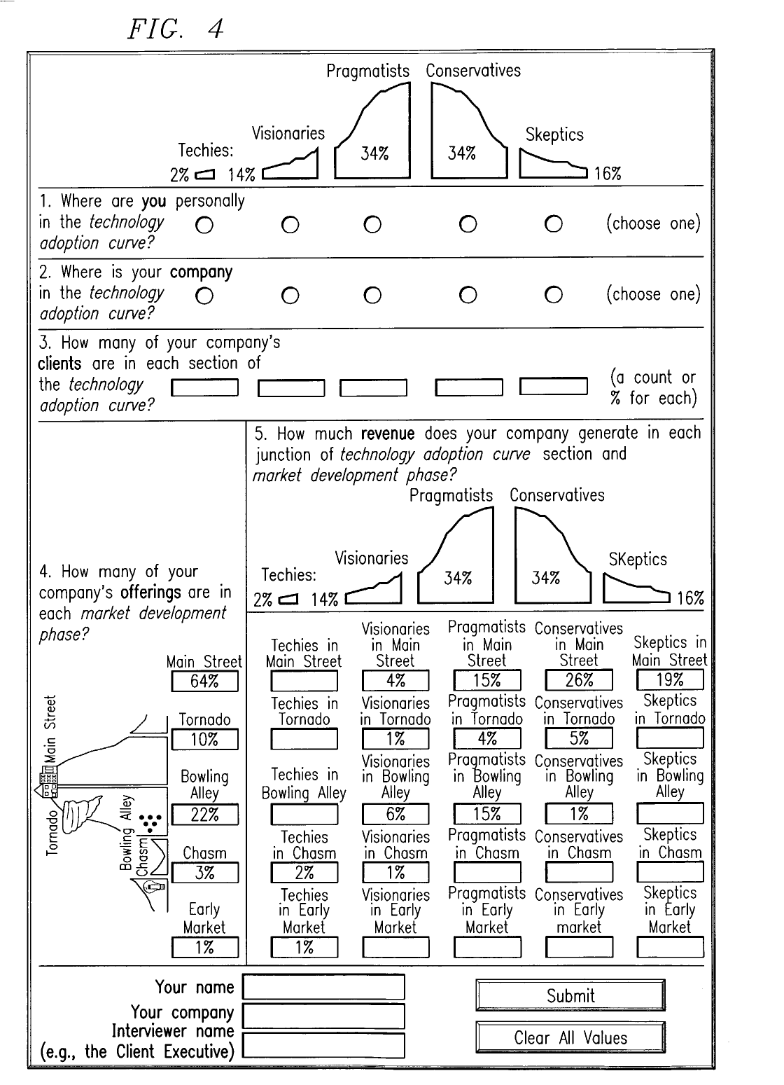

FIG. 1 is a block diagram illustrating a method for marketing whole product offerings to clients in accordance with one embodiment of the present invention. As used herein, a whole product offering may include a product offering, a service offering, or any combination thereof. As illustrated, method 100 includes a service profiling subprocess 102, a client profiling subprocess 104, a matching of services to clients subprocess 106, a matrix reporting subprocess 108, a portfolio management subprocess 110, a service packaging strategy subprocess 112, and a mega-deal support subprocess 114. Different subprocesses, fewer subprocesses, or more subprocesses are also contemplated by the present invention. In one embodiment, the subprocesses encompassed by dashed-line 116 may be performed by a computer 300 (FIG. 3), as described in further detail below.

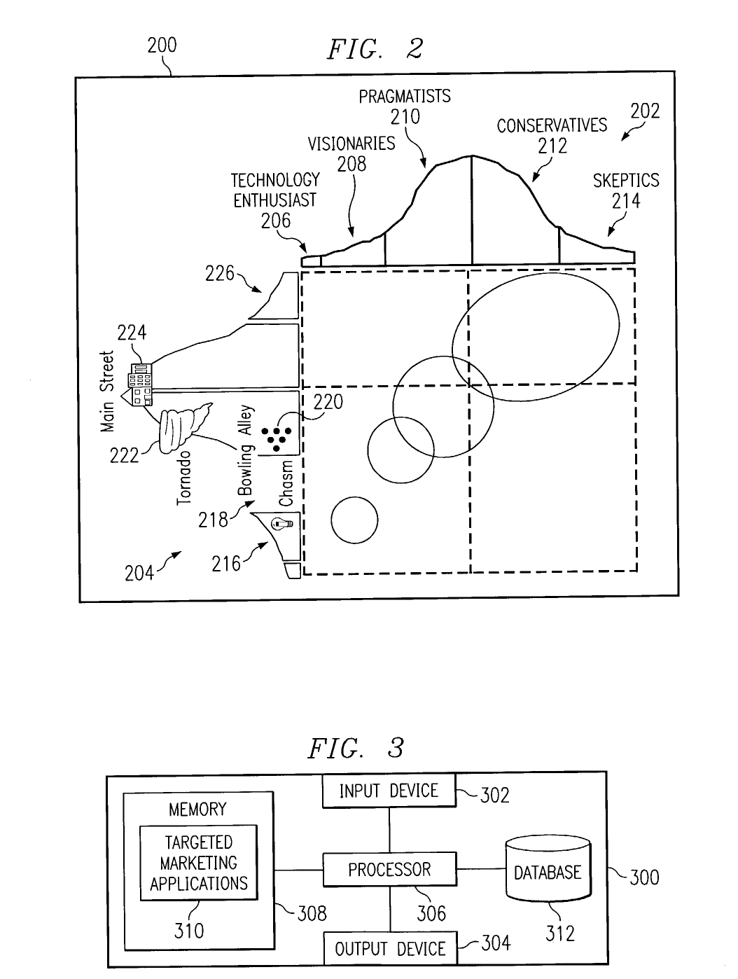

Service profiling subprocess 102 functions to enhance the list of whole product offerings that a company offers in a more meaningful manner. Most companies have a list of whole product offerings that are sorted alphabetically, grouped by line of business, or organized in another suitable manner. However, while each of these methods of presentation of whole product offerings may have a useful purpose, scanning them to see which whole product offering might be appropriate for a particular client is often difficult. The details of service profiling subprocess 102 are described below in conjunction with FIG. 2. Generally, service profiling subprocess 102 enables a company's whole product offering managers, such as account managers, to characterize each whole product offering in terms of a technology market development phase model or other suitable model that classifies a whole product offering based on where the whole product offering is in its lifecycle. For example, the whole product offering may be a new service, an adopted service, a market saturated service, or a whole product offering that is at the end of its lifecycle. In a particular embodiment, whole product offerings are classified according to Geoffrey Moore's published technological maturity market phases model, which breaks down the phases into Early Market, Chasm, Bowling Alley, Tornado, and Main Street, which is described in further detail below. Service profiling subprocess 102 may be utilized to periodically reevaluate whole product offerings of a company because their technological maturity changes over time.

Client profiling subprocess 104 functions to characterize existing and potential clients and their respondents. A respondent of a client is typically a purchaser of a client; however, a respondent as used herein may be any suitable employee of a client. In one embodiment, Everett Rogers' published Technology Adoption Profile is used to associate a respondent with one or more segments of the Technology Adoption Profile. According to Everett Rogers' published Technology Adoption Profile, the segments are as follows: Technology Enthusiast's segment, a Visionary's segment, a Pragmatist's segment, a Conservative's segment, and a Skeptic's segment. In other embodiments, other client profiles may be utilized that are suitable for assessing a client's ability to adopt innovations, absorb them, and use them. Details of client profiling subprocess 104 are described further below in conjunction with FIG. 2. Generally, information about one or more respondents of a particular client are accumulated into a higher order profile of a client. This reflects the fact that different decision-makers may have different profiles within a single client and the fact that localized groups of decision-makers may form within the overall client organization. Once it is known where a particular respondent of a client is located within their company's technology adoption profile, whole product offerings may be marketed toward that particular respondent in a cost-effective and productive manner. Client profiling subprocess 104 may be utilized to periodically reevaluate clients and/or their respondents because the technology adoption profile may change over time, the set of decision-makers within the client may change over time, or a particular respondent may change segments over time.

Matching of services to clients subprocess 106 is described in further detail below in conjunction with FIGS. 2 and 3. Generally, matching of services to clients subprocess 106 is performed according to the clients' technology adoption profile determined at client profiling subprocess 104 and a company's whole product offering technology market development phase model determined at service profiling subprocess 102. The matching of whole product offerings to clients depends on which particular models and curves were chosen for each of service profiling subprocess 102 and client profiling subprocess 104. According to the teachings of one embodiment of the present invention, the matching may be that Early Market whole product offerings are matched to respondents of a client in the Technology Enthusiasts segment, Bowling Alley whole product offerings may be matched to respondents in the Pragmatists segment and Main Street whole product offerings matched to respondents in the Conservative and/or Skeptics segment. Generally, the “newer” whole product offerings are matched to respondents who adopt a new technology based on its first appearance to see how it works and how “cool” it is, and “older” whole product offerings are matched to respondents who generally stick with old, proven technologies. Matching is repeated over time whenever a whole product offering changes, a client's technology adoption profile changes, or a respondent of the client changes from one segment to another.

Matrix reporting subprocess 108 functions to provide access to the information developed by service profiling subprocess 102, client profiling subprocess 104, and matching of services to client subprocess 106. Matrix reporting subprocess 108 allows employees of a company, such as account managers or other suitable managers, to view information in a usable form so that educated decisions may be made with regard to marketing whole product offerings to clients. One usable form is a graph 200 (FIG. 2) that is an output from matching of services to clients subprocess 106.

Portfolio management subprocess 110 allows a portfolio manager of a company to identify patterns developing as a result of the previous subprocesses. In other words, a portfolio manager, through the outputs obtained from matrix reporting subprocess 108, may be able to determine that there is an overload of self competing whole product offerings in one category and, consequently, to decide to merge two whole product offerings. Also, a portfolio manager may be able to determine that a gap exists that could be filled by a new whole product offering or may be able to determine that a whole product offering should be eradicated because of lack of demand or other reason. Portfolio management subprocess 110 may be performed, in whole or in part, by computer 300 or may be manually performed by any suitable employee of a company.

Service packaging strategy subprocess 112 allows any suitable employee of a company to identify an appropriate way to package each whole product offering based on its technological maturity phase and where a respondent of a client falls on the technology adoption profile for that client. For example, account managers of a company may, as a result of the reports generated by graph reporting subprocess 108, determine that a particular set of whole product offerings could be packaged and marketed to a particular respondent of a client, thereby enhancing the profitability of the whole product offerings to the company. Service packaging strategy subprocess 112 may be performed, in whole or in part, by computer 300 or may be manually performed by any suitable employee of a company.

Mega-deal support subprocess 114 facilitates the demonstration to clients or respondents of clients that a company is a great long-term business partner. For example, even though a client may only be comfortable purchasing whole product offerings of a particular phase of technology maturity, the results illustrated by graph reporting subprocess 108 may be demonstrated to a client or a respondent of a client so that a client or respondent may recognize which whole product offerings they may be comfortable with in the future based on its technological maturity level and where that particular respondent of the client is within the client's technology adoption profile. Clients may then see that a company is offering a stream of ever more technologically advanced whole product offerings at the level of maturity with which they are comfortable and not just a single whole product offering. This may demonstrate to a particular client that a company is able to be their long-term source of comprehensive whole product solutions. Mega-deal support subprocess 114 may be performed, in whole or in part, by computer 300 or may be manually performed by any suitable employee of a company.

As mentioned above, FIG. 2 illustrates a graph 200 that is a result of matching of services to clients subprocess 106 in FIG. 1. In the illustrated embodiment, graph 200 includes a technology adoption profile 202 of a client and a technology market development phase model 204 of a plurality of whole product offerings of a company. FIG. 2 only illustrates one embodiment of a result of matching of services to clients subprocess 108. Other matrices, graphs, charts, or other suitable reports are contemplated by the present invention depending on what type of technology adoption profile 202 is utilized and the type of technology market development phase model 204 utilized.

As illustrated in FIG. 2, technology adoption profile 202 includes, in this embodiment, a technology enthusiasts segment 206, a visionaries segment 208, a pragmatists segment 210, a conservatives segment 212, and a skeptics segment 214. Technology adoption profile 202 generally follows a bell-shaped curve; however, other shapes may result depending on the particular client or potential client. As described above, any number of suitable segments may be utilized depending on the type of technology adoption profile 202 utilized. In the illustrated embodiment, technology adoption profile 202 is similar to Everett Rogers' Technology Adoption Profile that was developed in the 1960s. In another embodiment, technology adoption profile 202 is similar to Peter F. Druckers' Business X-Ray of Universal Products model. Generally, technology adoption profiles are summaries of behavior patterns and are determined by psychological and cultural factors that influence communication networks and technology comfort levels. For example, respondents of a client that are within technology enthusiasts segment 206 are generally ones that adopt a new technology based on its first appearance to see how it works and how “cool” it is, ones who are in visionaries segment 208 are generally ones who adopt a new technology to get a leg up on the competition, ones who are in pragmatists segment 210 generally adopt new technology only if others have also, ones who are in conservatives segment 212 generally stick with old, proven technologies, and ones who are in skeptics segment 214 typically debunk the technology as a false start and refuse to adopt it at all.

One way to obtain technology adoption profile 202 is to have account managers familiar with the client to categorize respondents of the client into the various segments of the technology adoption profile 202. In another embodiment, answers to a provided questionnaire in conjunction with a predefined key for its questions determine the technology adoption profile 202 for that particular client. A plurality of respondents of a client may be queried and, based on the information obtained from this querying, the technology adoption profile 202 may be generated. An example of a set of questions that may be given to a respondent of a client is shown and described below in conjunction with FIG. 4. Any suitable number of types of questions may be asked of a respondent of a client to identify which segment of the technology adoption profile 202 they fall in.

In the illustrated embodiment, technology market development phase model 204 includes an early market phase 216, a chasm phase 218, a bowling alley phase 220, a tornado phase 222, a main street phase 224, and an end-of-life phase 226. Technology market development phase model 204 generally classifies the whole product offerings of a company based on their technological lifecycle. For example, a new and exciting new whole product offering may be categorized into early market phase 216, while an old whole product offering that is obsolete, is becoming obsolete, or that no one wants to use anymore may fall in end-of-life phase 226. Technology market development phase model 204 generally follows Geoffrey Moore's published technological maturity market phases model. However, other suitable technology market development phase models may be utilized, and any number of suitable phases having any suitable names may be utilized.

One way of identifying where a whole product offering falls on the technology market development phase model 204 is to have an employee of a company familiar with the whole product offerings of the company classify each whole product offering into a particular phase of model 204. Another way is to obtain answers to a provided questionnaire in conjunction with a predefined key for its questions to employees of the company. Any suitable number of questions and types of questions may be utilized to obtain technology market development phase model 204 for a particular company's whole product offerings. These whole product offerings are continually updated because the life cycle of the whole product offerings are ever evolving.

The circles within graph 200 represent one possible result of matching of services to client subprocess 106. In other words, a particular whole product offering may be within main street phase 224. Graph 200 illustrates that this whole product offering should be marketed to the respondent of a client that is within either the conservative's segment 212 or the skeptic's segment 214. On the other hand, a particular whole product offering that is in early market phase 216 should be marketed to a respondent of a client that is in visionaries segment 208. A technical advantage of the present invention that may be gleaned from graph 200 is that some of the whole product offerings are on the edge of a particular phase of the technology market development phase model 204 and similarly a respondent of a client may be on the border of one of the segments of the technology adoption profile 202 of the client. A client-serving employee, as a result of graph 200, may identify that a particular respondent of a client is very close to being within the technology enthusiasts segment 206 and because a whole product offering of his or her company is within bowling alley phase 220 of the technology market development phase model 204 but is close to early market phase 216 then he or she could market that particular whole product offering to that particular client because that particular respondent may soon be within technology enthusiasts segment 206.

As described above, graph 200 is one possible output generated by matrix reporting subprocess 108 as a result of matching of services to client's subprocess 106. Graph 200 may be generated by computer 300; however, graph 200 may be generated by other suitable methods.

FIG. 3 is a block diagram of computer 300 for use in marketing whole product offerings to clients according to one embodiment of the present invention. Computer 300 may be any suitable general purpose computer. Computer 300 includes an input device 302, an output device 304, a processor 306, a memory 308 storing targeted marketing application 310, and database 312.

Input device 302 is coupled to computer 300 for the purpose of inputting information, such as a classification of a particular whole product offering, or for inputting desired outputs from matching of services to client subprocess 106. In one embodiment, input device 302 is a keyboard; however, input device 302 may take other forms, such as a mouse, a stylus, or a scanner. Output device 304 may be any suitable visual display unit, such as a liquid crystal display (“LCD”) or cathode ray tube (“CRT”) display. Output device 304 may also be coupled to a printer (not shown) for the purpose of printing out any desired information, such as graph 200 (FIG. 2).

Processor 306 comprises any suitable type of processing unit that executes logic. One of the functions of processor 306 is to retrieve targeted marketing application 310 from memory 308 and execute targeted marketing application 310 to develop graph 200, as described more fully below. Processor 306 also controls the retrieving of information and data stored in database 312 or other suitable storage location of computer 300. Such information may include such things as information on a particular client or a particular whole product offering or offerings of a company.

Targeted marketing application 310 is a computer program written in any suitable computer language that is operable, in one embodiment, to perform service profiling subprocess 102, client profiling subprocess 104, and matching of services to clients subprocess 106 to generate graph 200 so that a client-serving employee of a company is better able to market whole product offerings to respondents and/or clients more effectively. In the illustrated embodiment, targeted marketing application 310 is logic encoded in memory 308. However, in alternative embodiments, targeted marketing application 310 is implemented through application specific integrated circuits (“ASICs”), field programmable gate arrays (“FPGAs”), digital signal processors (“DSP”), or other suitable specific or general purpose processors.

Memory 308 and database 312 may comprise files, stacks, databases, or other suitable organizations of volatile or nonvolatile memory. Memory 308 and database 312 may be random access memory, read-only memory, CD-ROM, removable memory devices, or any other suitable devices that allow storage and/or retrieval of data. Memory 308 and database 312 are interchangeable and may perform the same functions.

FIG. 4 illustrates example queries presented to a respondent of a client in accordance with one embodiment of the present invention. The queries illustrated in FIG. 4 are merely exemplary queries that may be presented to a respondent of a client. Any number of questions and any type of question suitable to obtain a technology adoption profile for a client may be presented to a respondent of a client. In the illustrated example, question #1 asks, “Where are you personally in the technology adoption curve?” The answer to this question would be the respondent's perception of themselves on where they fall within the technology adoption curve. Question #2 identifies the respondent's perception of their company on where they think their company falls within the technology adoption curve. Question #3 identifies the respondent's subjective view as to where he or she thinks each of the company's clients are in the technology adoption curve. Question #4 allows the respondent to illustrate his or her view of where they think their company's offerings are in each technology market development phase, while question #5 is that respondent's particular approximation of how much revenue their company generates in each segment of the technology adoption curve with respect to the technology market development phase that was predicted in question #4.

The questions illustrated in FIG. 4 may be presented to any number of respondents of a client or of a company to try to obtain the technology adoption curve and/or the technology market development phase curve for a particular client or of a company. The questions may be presented in hardcopy form or electronic form. The answers to the queries may be stored in database 312 of computer 300 (FIG. 3) until needed at a later time.

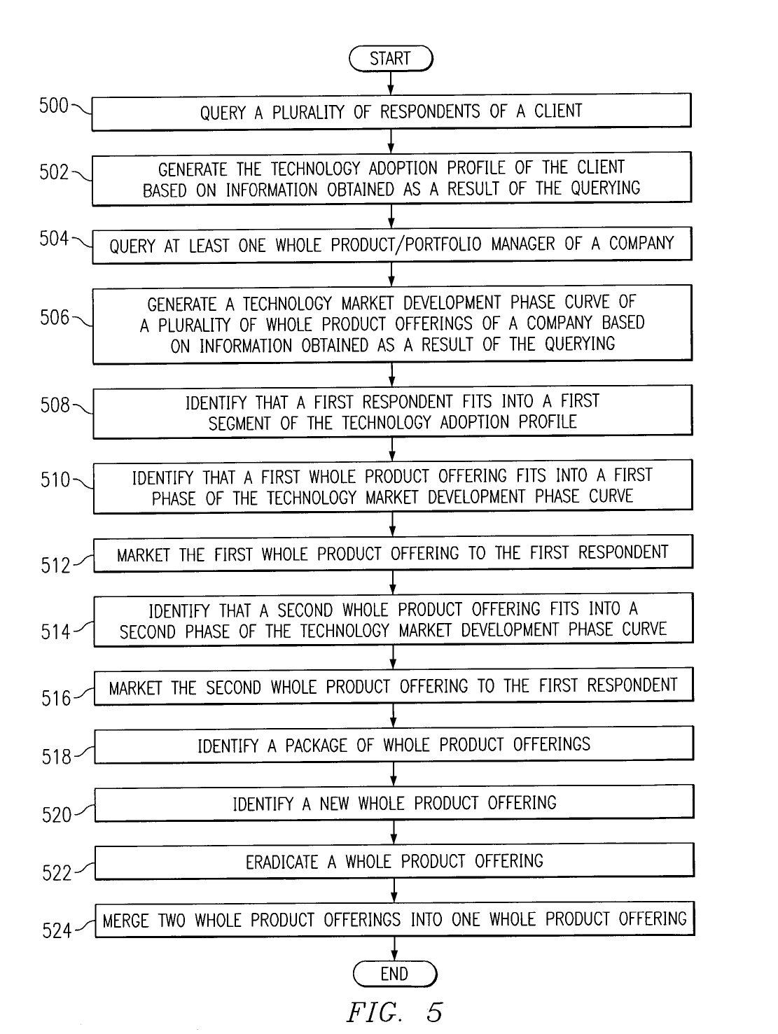

FIG. 5 is a flowchart illustrating one method of marketing whole product offerings to clients according to one embodiment of the present invention. Some of the following steps may be performed by computer 300 via targeted marketing application 310. The method begins at step 500 where a plurality of respondents of a client are queried. Some of the queries may take the form of what is illustrated in FIG. 4. Based on the information obtained as a result of the querying, the technology adoption profile of the client is generated at step 502. An example technology adoption profile of the client is illustrated in FIG. 2. Steps 500 and 502 may be performed within client profiling subprocess 104 as illustrated in FIG. 1.

At least one whole product offering manager (or portfolio manager) of a company is queried at step 504 to generate a technology market development phase model of a plurality of whole product offerings of a company, at step 506, based on the information obtained as a result of the querying. Any suitable queries may be presented to the whole product offering manager or the whole product offering manager may be able to classify his company's whole product offerings based on his inherent knowledge. An example technology market development phase model of a plurality of whole product offerings of a company is also illustrated in FIG. 2. Steps 504 and 506 may be performed within service profiling subprocess 102 as illustrated in FIG. 1.

Identifying that a first respondent of a client fits into a first segment of the technology adoption profile of that particular client is performed at step 508. Identifying that a first whole product offering fits into a first phase of a technology market development phase model is performed at step 510. The first whole product offering may then be marketed to the first respondent at step 512. Steps 508, 510, and 512 are performed within matching of services to clients subprocess 106 as illustrated in FIG. 1. According to the teachings of one embodiment of the present invention, the marketing may be that Early Market whole product offerings are marketed to respondents of a client in the Technology Enthusiasts segment, Bowling Alley whole product offerings may be marketed to respondents in the Pragmatists segment and Main Street whole product offerings marketed to respondents in the Conservative and/or Skeptics segment.

Identifying that a second whole product offering fits into a second phase of the technology market development phase model may be done at step 514 so that the second whole product offering may be marketed, at step 516, to the first respondent. Steps 514 and 516 may also be performed by matching of services to clients subprocess 106 in FIG. 1.

Other steps that may be performed by the method outlined in FIG. 5 include identifying a package of whole product offerings to be marketed to a respondent of the client at step 518, identifying a new whole product offering for a company at step 520, eradicating a whole product offering of a company at step 522, and/or merging two whole product offerings into one whole product offering at step 524. Steps 518, 520, 522, and 524 may be performed as a result of the matrix reporting subprocess 108 in FIG. 1, and may be performed in the portfolio management subprocess 110, service packaging strategy subprocess 112, and/or mega-deal support subprocess 114 as outlined in FIG. 1.

Another set of steps that may be performed by another embodiment of the method outlined in FIG. 5 include identifying a client factor, identifying a company factor, comparing the client factor to the company factor, and determining whether to market a whole product offering to a respondent based, at least in part, on the comparison of the client factor and the company factor. A client factor is defined as some known fact about the client that is not captured by the clients' technology adoption profile, and a company factor is defined as some known fact about the company that is not captured by company's technology market development phase curve. Thus, for example, a client's computers may only have the UNIX operating system, while a particular whole product offering of a company may not be supported by a UNIX operating system. Therefore, that whole product offering would not want to be marketed to that particular client.

Although embodiments of the invention and their advantages are described in detail, a person skilled in the art could make various alterations, additions, and omissions without departing from the spirit and scope of the present invention as defined by the appended claims.

What is claimed is:

1. A computerized method used in marketing whole product offerings to clients, comprising:
identifying that a first respondent of a client fits into a first segment of a plurality of segments of a technology adoption profile for the client;
identifying that a first whole product offering of a company fits into a first phase of a plurality of phases of a technology market development phase model for a plurality of whole product offerings of the company;
comparing the first segment to the first phase; and
generating an output, based on the comparison, to determine whether to market the first whole product offering to the first respondent.

2. The computerized method of claim 1, wherein identifying that the first respondent of the client fits into the first segment comprises:
querying the first respondent; and
receiving information from the first respondent representative of a subjective evaluation of the first respondent's perception of where the first respondent fits within the technology adoption profile.

3. The computerized method of claim 1, wherein identifying that the first whole product offering fits into the first phase comprises:
querying a whole product offering manager of the company; and
receiving information from the whole product offering manager representative of a subjective evaluation of the whole product offering manager's perception of where the first whole product offering fits within the technology market development phase model.

4. The computerized method of claim 1, further comprising:
querying a plurality of respondents of the client;
receiving information from the respondents; and
generating the technology adoption profile of the client based on the received information.

5. The computerized method of claim 1, further comprising:
querying a plurality of whole product offering managers of the company;
receiving information from the whole product offering managers with respect to the whole product offerings of the company; and
generating the technology market development phase model for the whole product offerings based on the received information, the technology market development phase model having a plurality of phases that each represent a technological maturity level for the whole product offerings.

6. The computerized method of claim 1, further comprising:
identifying that a second whole product offering fits into a second phase of the plurality of phases; and
comparing the first segment to the second phase; and
generating the output, based on the comparison, to determine whether to market the second whole product offering to the first respondent.

7. The computerized method of claim 1, wherein the technology adoption profile includes a technology enthusiasts segment, a visionaries segment, a pragmatists segment, a conservatives segment, and a skeptics segment.

8. The computerized method of claim 1, wherein the technology market development phase model includes an early market phase, a bowling alley phase, a tornado phase, a main stream phase, and a end of life phase.

9. The computerized method of claim 1, further comprising:
identifying a package of whole product offerings based on the respective phases that the whole product offerings fit into on the technology market development phase model; and
generating the output to determine whether to market the package to the first respondent.

10. The computerized method of claim 1, further comprising identifying a new whole product offering based on the technology adoption profile and the technology market development phase model.

11. The computerized method of claim 1, further comprising eradicating a whole product offering based on the technology adoption profile and the technology market development phase model.

12. The computerized method of claim 1, further comprising merging two whole product offerings into one whole product offering based on the technology adoption profile and the technology market development phase model.

13. The computerized method of claim 1, further comprising:
identifying a client factor;
identifying a company factor;
comparing the client factor to the company factor; and
generating the output to determine whether to market the first whole product offering to the first respondent based, at least in part, on the comparison of the client factor and the company factor.

14. Logic encoded in media for use in marketing whole product offerings to clients, the logic operable to perform the following steps:
identify that a first respondent of a client fits into a first segment of a plurality of segments of a technology adoption profile for the client;
identify that a first whole product offering of a company fits into a first phase of a plurality of phases of a technology market development phase model for a plurality of whole product offerings of the company;
compare the first segment to the first phase; and
generate an output, based on the comparison, to determine whether to market the first whole product offering to the first respondent.

15. The logic encoded in media of claim 14, wherein the logic is further operable to:
query the first respondent; and
receive information from the first respondent representative of a subjective evaluation of the first respondent's perception of where the first respondent fits within the technology adoption profile.

16. The logic encoded in media of claim 14, wherein the logic is further operable to:
query a whole product offering manager of the company; and
receive information from the whole product offering manager representative of a subjective evaluation of the whole product offering manager's perception of where the first whole product offering fits within the technology market development phase model.

17. The logic encoded in media of claim 14, wherein the logic is further operable to:
query a plurality of respondents of the client;
receive information from the respondents; and
generate the technology adoption profile of the client based on the received information.

18. The logic encoded in media of claim 14, wherein the logic is further operable to:
query a plurality of whole product offering managers of the company;
receive information from the whole product offering managers with respect to the whole product offerings of the company; and
generate the technology market development phase model for the whole product offerings based on the received information, the technology market development phase model having a plurality of phases that each represent a technological maturity level for the whole product offerings.

19. The logic encoded in media of claim 14, wherein the logic is further operable to:
identify that a second whole product offering fits into a second phase of the plurality of phases; and
compare the first segment to the second phase; and
generate the output, based on the comparison, to determine whether to market the second whole product offering to the first respondent.

20. The logic encoded in media of claim 14, wherein the technology adoption profile includes a technology enthusiasts segment, a visionaries segment, a pragmatists segment, a conservatives segment, and a skeptics segment.

21. The logic encoded in media of claim 14, wherein the technology market development phase model includes an early market phase, a bowling alley phase, a tornado phase, a main stream phase, and a end of life phase.

22. The logic encoded in media of claim 14, wherein the logic is further operable to:
identify a package of whole product offerings based on the respective phases that the whole product offerings fit into on the technology market development phase model; and
generate the output to determine whether to market the package to the first respondent.

23. A computerized method used in marketing whole product offerings to clients, comprising:
querying a plurality of respondents of a client;
receiving information from the respondents;
generating a technology adoption profile for the client based on the received information, the technology adoption profile including a technology enthusiasts segment, a visionaries segment, a pragmatists segment, a conservatives segment, and a skeptics segment;
identifying that a first respondent of the client fits into a first segment of the technology adoption profile;
identifying that a first whole product offering of a company fits into a first phase of a plurality of phases of a technology market development phase model for a plurality of whole product offerings of the company;
comparing the first segment to the first phase; and
generating an output, based on the comparison, to determine whether to market the first whole product offering to the first respondent.

24. The computerized method of claim 23, wherein identifying that the first whole product offering fits into the first phase comprises:
querying a whole product offering manager of the company; and
receiving information from the whole product offering manager representative of a subjective evaluation of the whole product offering manager's perception of where the first whole product offering fits within the technology market development phase model.

25. The computerized method of claim 23, further comprising:
identifying that a second whole product offering fits into a second phase of the plurality of phases; and
comparing the first segment to the second phase; and
generating the output, based on the comparison, to determine whether to market the second whole product offering to the first respondent.

26. The computerized method of claim 23, wherein the technology market development phase model includes an early market phase, a bowling alley phase, a tornado phase, a main stream phase, and a end of life phase.

27. The computerized method of claim 23, further comprising:
identifying a package of whole product offerings based on the respective phases that the whole product offerings fit into on the technology market development phase model; and
generating the output to determine whether to market the package to the first respondent.

28. The computerized method of claim 23, further comprising identifying a new whole product offering based on the technology adoption profile and the technology market development phase model.

29. The computerized method of claim 23, further comprising eradicating a whole product offering based on the technology adoption profile and the technology market development phase model.

30. The computerized method of claim 23, further comprising merging two whole product offerings into one whole product offering based on the technology adoption profile and the technology market development phase model.
